(19) United States
(12) Patent Application Publication
(10) Pub. No.: US 2014/0164263 A1
(43) Pub. Date: Jun. 12, 2014

(54) Jury Deliberation Selection Measure

(71) Applicants: Bernard Francis Pettingill, Palm Beach Gardens, FL (US); Nils Westerlund, Palm Beach Gardens, FL (US); Kaushik Chatterjee, Palm Beach Gardens, FL (US); Rajagopal Yadavalli, Palm Beach Gardens, FL (US)

(72) Inventors: Bernard Francis Pettingill, Palm Beach Gardens, FL (US); Nils Westerlund, Palm Beach Gardens, FL (US); Kaushik Chatterjee, Palm Beach Gardens, FL (US); Rajagopal Yadavalli, Palm Beach Gardens, FL (US)

(21) Appl. No.: 13/712,354

(22) Filed: Dec. 12, 2012

(51) Int. Cl. G06Q 50/18

(52) U.S. Cl. CPC G06Q 50/18; G06Q 10/063
USPC 705/311

(57) ABSTRACT

Jury Deliberation Selection Measure is a method utilizing a secure interne cloud or device specific application secure graphical user interface gateway from anywhere on numerous mobile or non-mobile devices either wired or wireless. This includes a specific process for attorneys to set critical case parameters pre-trial, adding potential juror's name and address, then searching millions of public and social records in real time in order to obtain a Jury Deliberation Selection Measure numerical and color score, which can be updated by attorneys in real time during Voir Dire with updated Jury Deliberation Selection Measure numerical and color scoring, facilitating a final focused selection or deselection of potential jurors for the jury box. Finally, a composite jury box Jury Deliberation Selection Measure numerical and color score is determined.

### CROSS REFERENCE TO RELATED APPLICATIONS

Powers et al (20100169106); Jeb C Griebat (20060198502); Louis Genevie (U.S. Pat. No. 6,607,389); Martin et al (20040054546); Carp et al (U.S. Pat. No. 6,640,213); Ehlert et al (20100235217).

### THE NAMES OF THE PARTIES TO A JOINT RESEARCH AGREEMENT

Bernard Pettingill, PhD; Nils Westerlund, DPT; Kaushik Chatterjee; Rajagopal Yadavalli.

### BACKGROUND OF THE INVENTION

### Field of the Invention

In the United States, one has the right to a trial by jury, where a jury is selected through “Voir Dire”.

This selection process takes place in courtrooms, with attorneys' reviewing massive amounts of information from numerous sources via millions of wired or wireless mobile or non-mobile devices. Attorneys are faced with increasingly complex decisions, which are made expeditiously to select his or her preferred jury.

However, during this selection or deselection, there are countless variables considered and scrutinized simultaneously. During Voir Dire, each attorney attempts to formulate his or her own specific strategy to select the ideal jury. Attorneys analyze copious amounts of public and social information while questioning prospective jurors during Voir Dire to ultimately complete this process. All of this must be done quickly and competently with selection or deselection becoming critical to each case and ultimately impacting trial outcomes. Current methods of Voir Dire must still be improved and streamlined to assist attorneys due to these increasing demands, with the present invention uniquely filling this void.

### BRIEF SUMMARY OF THE INVENTION

In courtroom settings during Voir Dire, it has become a complex process with growing constraints being imposed on attorneys. As a consequence, they have inadequate time to meticulously record and analyze information. It is an object of the present invention to provide a more efficient visual numerical and color scoring method to assist attorneys and thus streamline and accelerate jury selection or deselection. Providing attorneys with the ability to make quicker informed decisions will improve his or her confidence in their selections or deselection and ultimately verdicts.

To achieve the objectives in accordance with this invention as embodied and broadly described herein, this invention includes a unique process for selecting or deselecting jurors utilizing enhanced visual numerical and color scoring. The use of a numerical score ranging from 0-100 in order to provide visual feedback with lower numbers 0-49 indicating deselection and increasing numbers 50-100 indicating selection and color score ranging from red, orange, yellow, light green and finally dark green in order to provide visual feedback with the red end of the spectrum indicating deselection and the dark green end of the spectrum indicating selection. This will assist attorneys to provide quicker visual feedback and facilitate his or her selection or deselection of jurors. This invention is composed of the following steps: initial setup of critical case parameters from any location via wired or wireless prior to courtroom Voir Dire utilizing a secure graphical user interface with an application on Apple iOS or Google Android devices (or developing devices) or via secure browser interfaces such as Chrome, Internet Explorer, Firefox, Safari, Android, Opera (or developing platforms), inputting prospective juror name and address via secure graphical user interface, accessing and searching millions of public and social records via secure graphical user interface, obtaining JSDM numerical and color score based on critical case parameters, updating Jury Deliberation Selection Measure numerical and color score via secure graphical user interface during Voir Dire, obtaining updated or modified Jury Deliberation Selection Measure numerical and color score, selecting or deselecting jurors for Jury Box with image and details of jurors viewable in real time via secure graphical user interface. Additional advantages of this process and invention will be obvious from the detailed description or may be determined by actual invention utilization.

### BRIEF DESCRIPTION OF THE DRAWING(S)

The embodiments of this invention will be described in detail, with reference to the following figures:

FIG. 1 shows initial Jury Deliberation Selection Measure logo in accordance with the present invention;

FIG. 2 depicts the various mobile or non-mobile devices Jury Deliberation Selection Measure can be utilized on such as an Apple iOS device, Google Android device, Desktop system, Laptop system or other browser interfaces in accordance with the present invention;

FIG. 3 depicts Jury Deliberation Selection Measure being utilized at the attorney's office to input critical pre determined case parameters in accordance with the present invention;

FIG. 4 depicts Jury Deliberation Selection Measure main secure graphical user interface to start the process of case parameter setup in accordance with the present invention;

FIG. 5 depicts the Jury Deliberation Selection Measure secure login that can be accessed from any mobile or non-mobile device, anywhere via wired or wireless in accordance with the present invention;

FIG. 6 depicts the case setup or juror search in accordance with the present invention;

FIG. 7 depicts the case setup to add new case or search prior cases in the Jury Deliberation Selection Measure interface in accordance with the present invention;

FIG. 8 depicts creating a new case with critical case parameters via a secure graphical user interface to be utilized later during Voir Dire in accordance with the present invention;

FIG. 9 depicts the various categories and weighting for each showing demographics, political preference, occupation, religious preference and with other, other includes various sub sections in accordance with the present invention;

FIG. 10 depicts new case setup secure graphical user interface showing case name, weighting, state, county, plaintiff, Jury Deliberation Selection Measure numerical and color scoring, options and total jurors in accordance with the present invention;

FIG. 11 depicts initial search of potential juror with Jury Deliberation Selection Measure numerical and color score, quality correlation of data score and sub category colors for quick visual feedback in accordance with the present invention;

FIG. 12 depicts Jury Deliberation Selection Measure initial search with numerical and color scoring and image of potential juror in accordance with the present invention;

FIG. 13 depicts Jury Deliberation Selection Measure being utilized in court during Voir Dire in accordance with the present invention;

FIG. 14 depicts the attorney team selecting to input potential juror name in accordance with the present invention;

FIG. 15 depicts attorney team inputting potential juror with full name, city and state with preprogrammed drop down menus in accordance with the present invention;

FIG. 16 depicts output after information search to display initial Jury Deliberation Selection Measure numerical and color score of a potential juror in accordance with the present invention;

FIG. 17 depicts attorney during additional questioning in Voir Dire with attorney team inputting feedback into secure graphical user interface in accordance with the present invention;

FIG. 18 depicts the attorney team inputting the updated feedback into the Jury Deliberation Selection Measure secure graphical user interface on mobile or non-mobile devices with a wired or wireless connection in accordance with the present invention;

FIG. 19 depicts the attorney team inputting accident information into Jury Deliberation Selection Measure secure graphical user interface in accordance with the present invention;

FIG. 20 depicts the attorney team inputting other variables into Jury Deliberation Selection Measure secure graphical user interface in accordance with the present invention;

FIG. 21 depicts the breakout of the demographic category showing race, education, age and gender as well as political preference in accordance with the present invention;

FIG. 22 depicts the breakout of the occupation and religious preference in accordance with the present invention;

FIG. 23 depicts the breakout of the other category, other category shows prior accidents, property ownership, bankruptcy, corporate filings, preferences of news shows, personality types, a determination of skepticism, rules observed, optimistic or not plus open fields to input attorneys' own case specific variables with confirming weighting that sum to 100% in accordance with the present invention;

FIG. 24 depicts the updated or modified Jury Deliberation Selection Measure numerical and color score of potential juror in accordance with the present invention;

FIG. 25 again depicts updated or modified Jury Deliberation Selection Measure numerical and color score of potential juror in courtroom in accordance with the present invention;

FIG. 26 depicts additional jurors with aggregate Jury Deliberation Selection Measure numerical and color score for selected jury in accordance with the present invention;

FIG. 27 depicts a list of potential jurors, which are highlighted or shaded for the jury box and all other jurors without highlights, which can be selected or deselected for the jury box in accordance with the present invention;

FIG. 28 depicts the actual jury box, which can include photos (if allowable) with ability to print in accordance with the present invention;

FIG. 29 depicts the office setting again with the ability to access Jury Deliberation Selection Measure information and trail outcome in accordance with the present invention;

FIG. 30 depicts a diagram/flowchart of the method, showing Jury Deliberation Selection Measure secure data cloud, case setup with critical case parameters, Voir Dire with initial and updated juror input, internet access from Jury Deliberation Selection Measure cloud to obtain juror data, input/output of all data to generate Jury Deliberation Selection Measure numerical and color scoring, jury box selection with aggregate numerical and color scoring, Jury Deliberation Selection Measure cloud storage and purchasing in accordance with the present invention.

Although the present invention has been described and illustrated in detail, it is to be clearly understood that this is one selected illustration and is not to be taken as a limitation. The spirit and scope of the present invention are to be limited only by the terms of the claims.

### DETAILED DESCRIPTION OF THE INVENTION

Detailed description set forth below in connection with the drawing is intended as a description of the preferred embodiment of this invention; it is not intended to represent the only form in which the present invention may be designed or utilized. It is understood, however, that the same or equivalent functions may be accomplished by different configurations or embodiments, which can be accomplish within the scope and spirit of this invention.

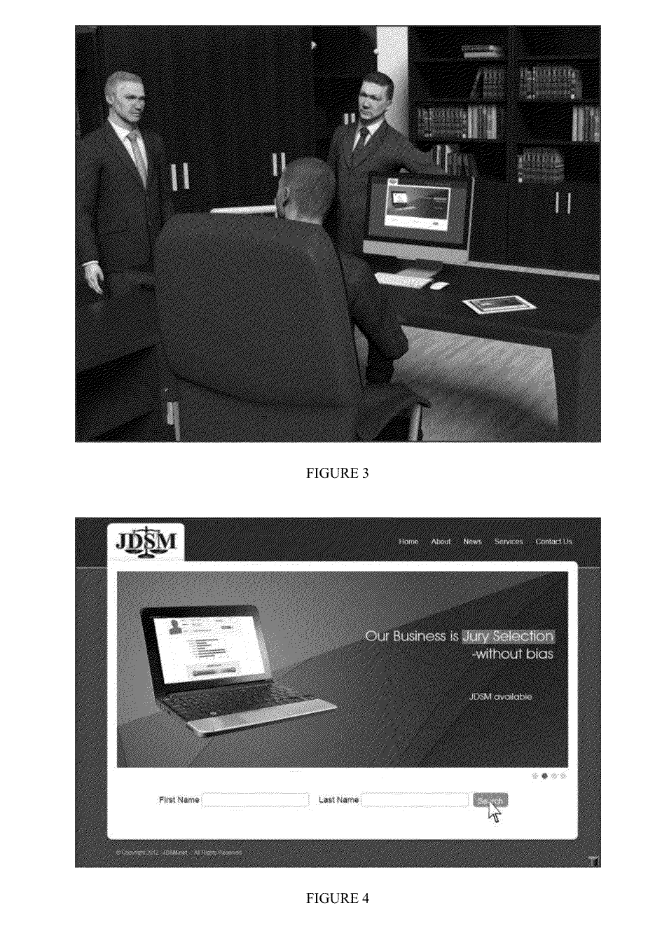

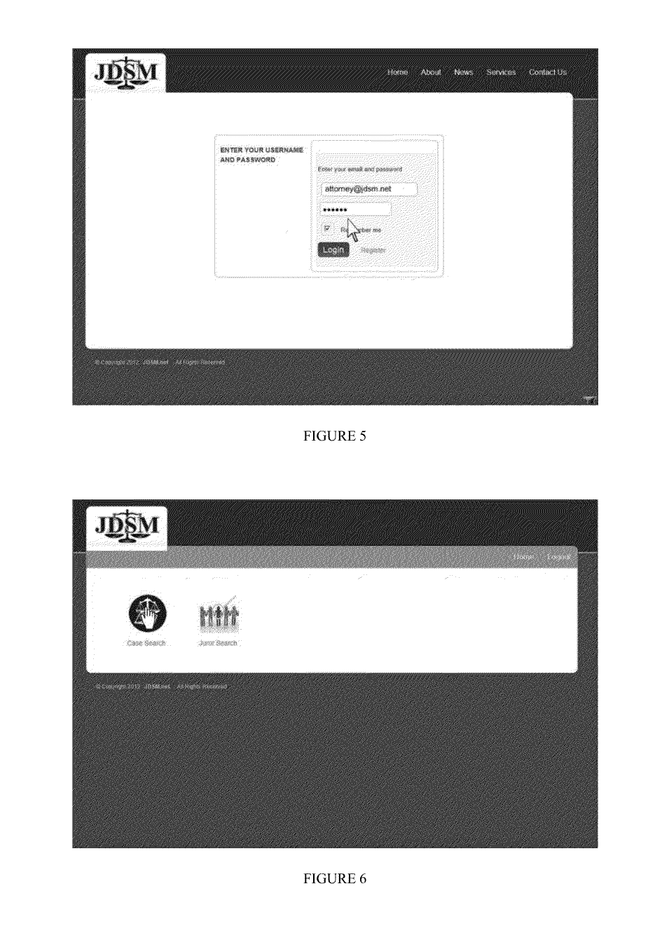

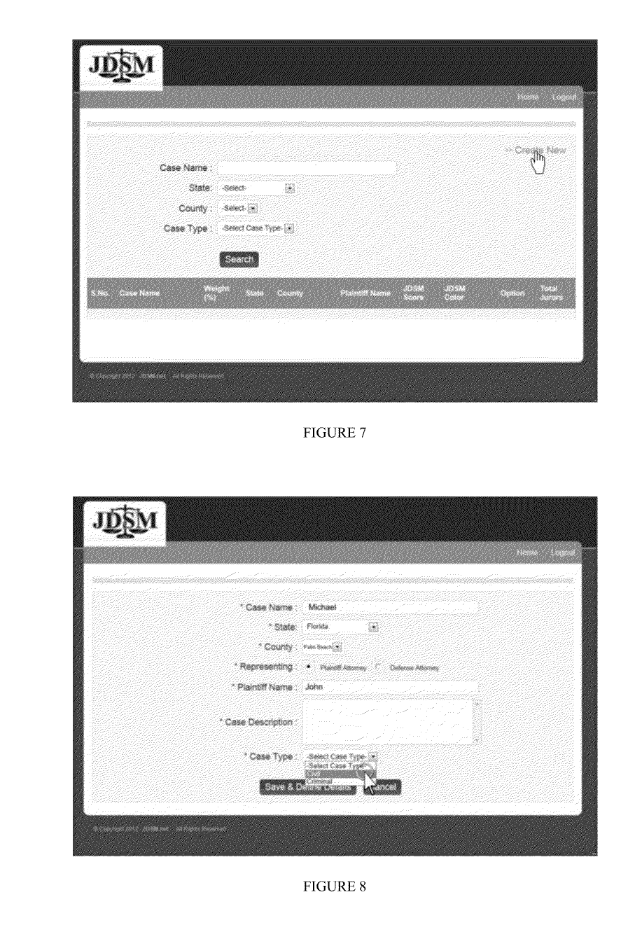

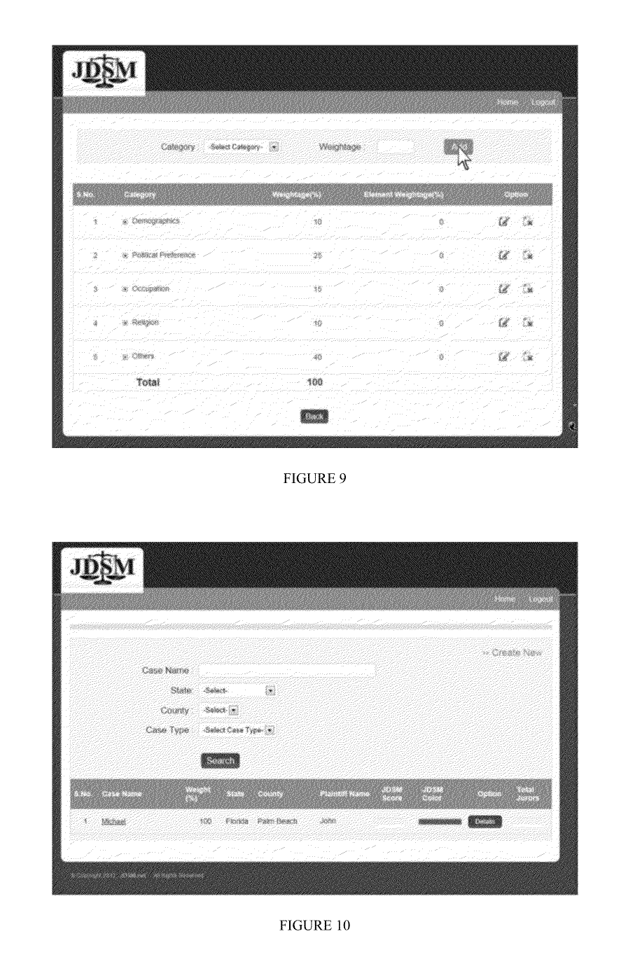

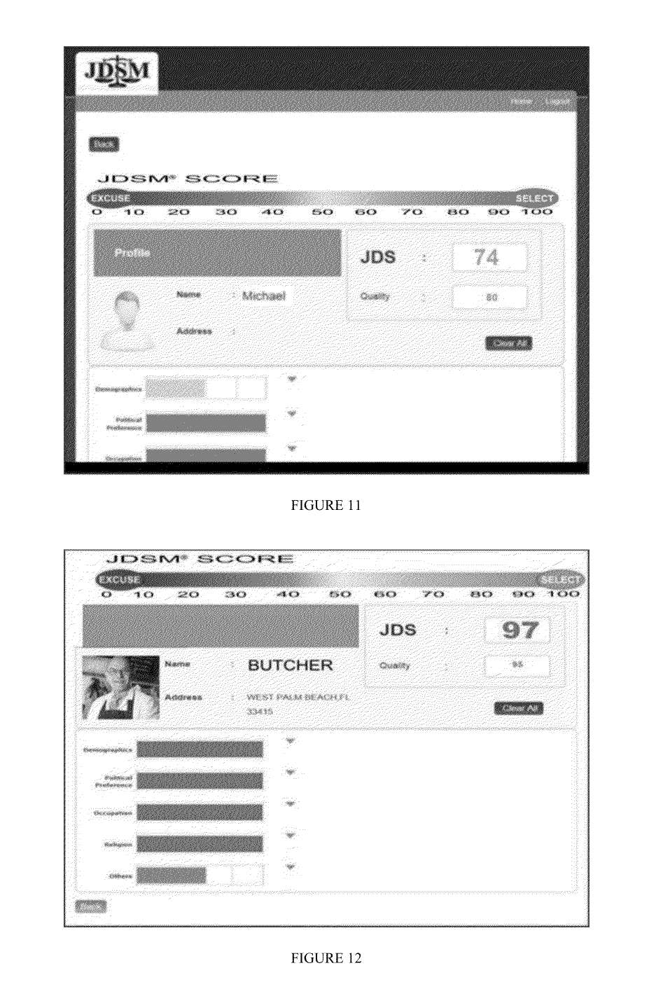

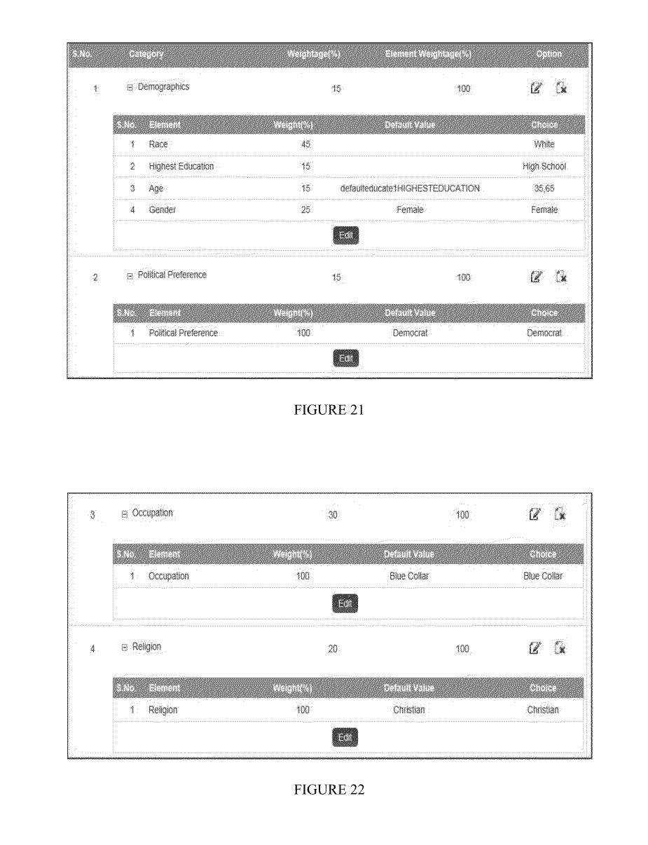

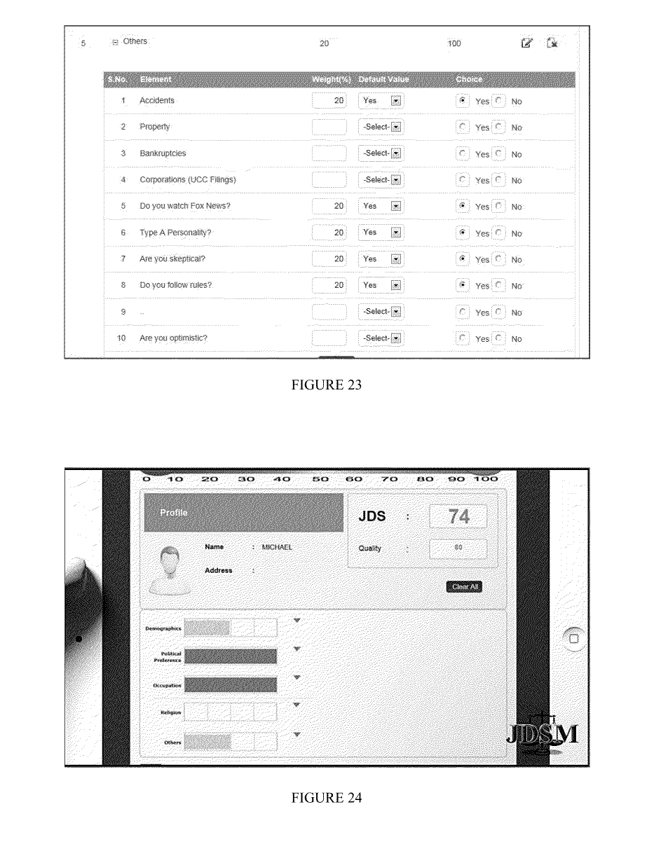

From within a secure graphical user interface (FIG. 5), the attorney will set up critical case parameters for each case (FIGS. 3, 6, 7, 8, 9, 10, 21, 22 & 23) and later prior to trial, enters the juror full name and address (FIGS. 14 & 15). Referring now to (FIG. 16), it shows user obtaining juror data instantaneously. In this embodiment, the invention also provides a quality correlation score (FIGS. 11, 12 & 24), which shows the correlation of juror data to preset critical case parameters.

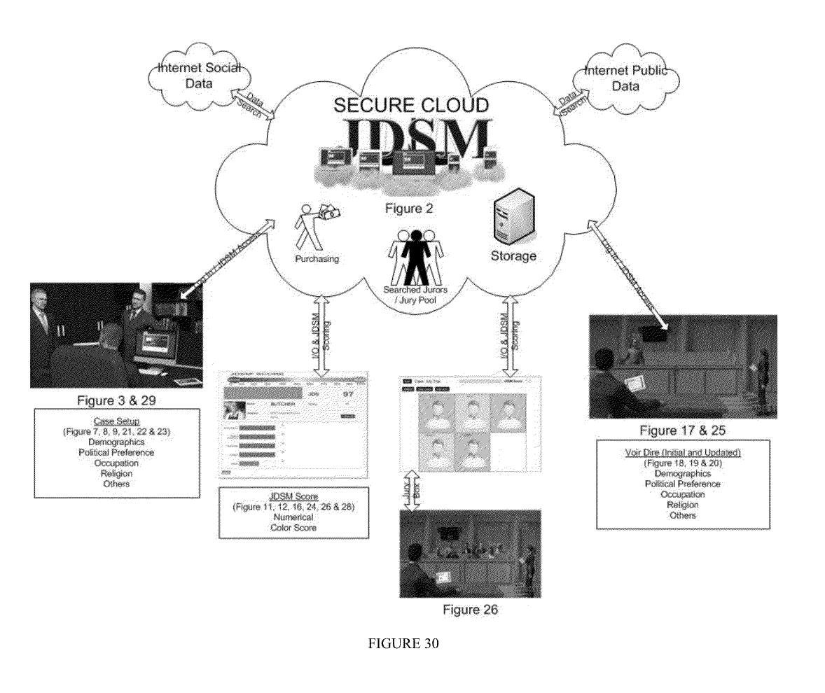

Based on numerical and color scores it also indicates the likelihood that an attorney may obtain a favorable trial outcome (FIG. 29). Note that while the illustrative embodiment shown in (FIG. 30) describes juror selection or deselection, this processes described herein could be applied to selection or deselection for teams, projects or employees.

In operation, the attorney communicates via a secure graphical user interface utilizing mobile or non-mobile devices such smart phones, iPhones, iPads, tablets, tablet PCs, laptops, netbooks, ultrabooks, personal computers, surfaces, data enabled phones with wired or wireless mobile or non-mobile devices utilizing a secure graphical user interface (FIG. 2) via application or browser, which is either a wired or wireless network protocol through an Internet Service Provider, Wide Area Network, Code Division Multiple Access, Evolution Data Optimized, Enhanced Data Rates for GSM Evolution, 3GSM, Digital AMPS, Integrated Digital Enhanced Network, WiMAX, Local Area Network, WiFi Protected Access, Peer to Peer, 3rd Generation, 3GPP Long Term Evolution, 4th Generation or Virtual Private Network.

Using data mining algorithms and analytic concepts from Han et al, Data Mining: Concepts and Techniques, Third Edition, and Witten et al, Data Mining: Practical Machine Learning Tools and Techniques, Third Edition both from the Morgan Kaufmann Series in Data Management Systems.

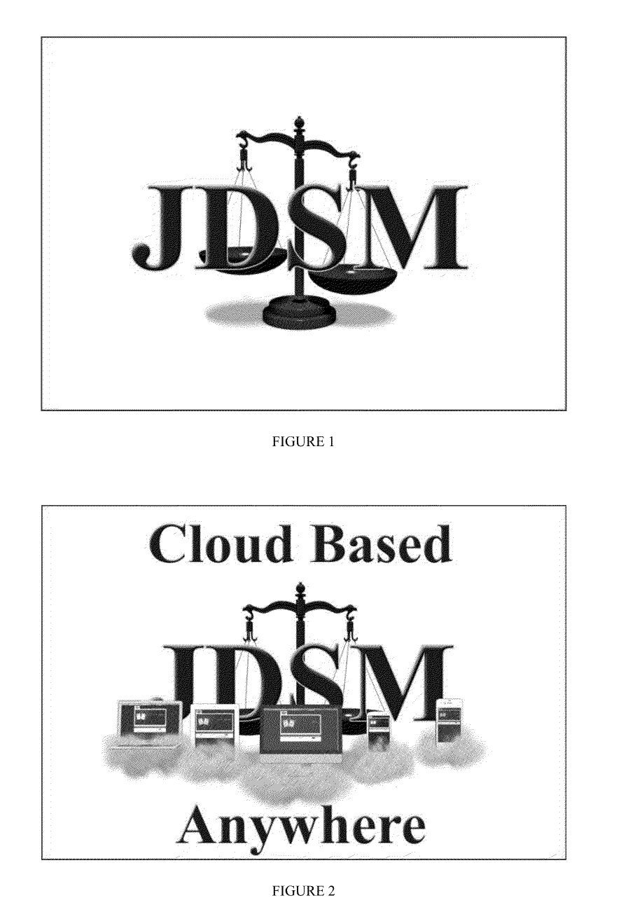

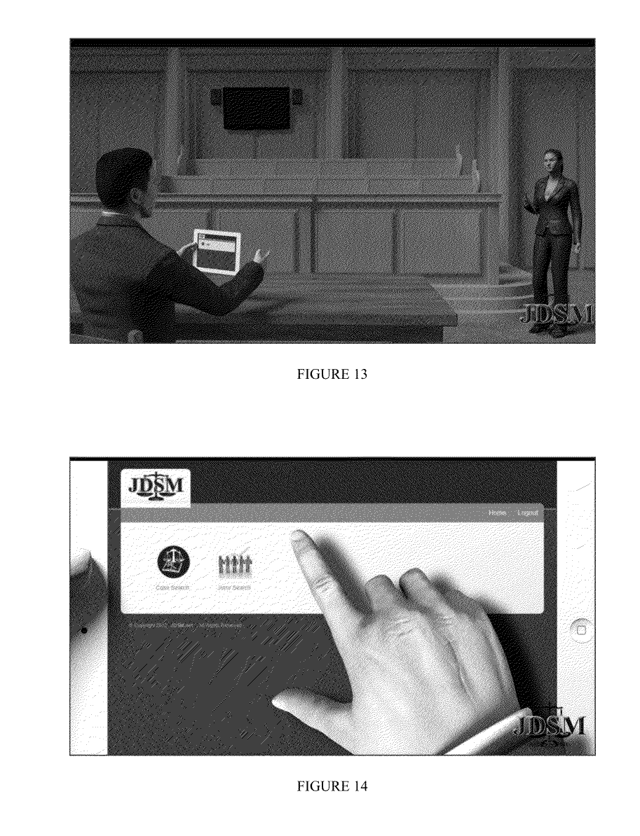

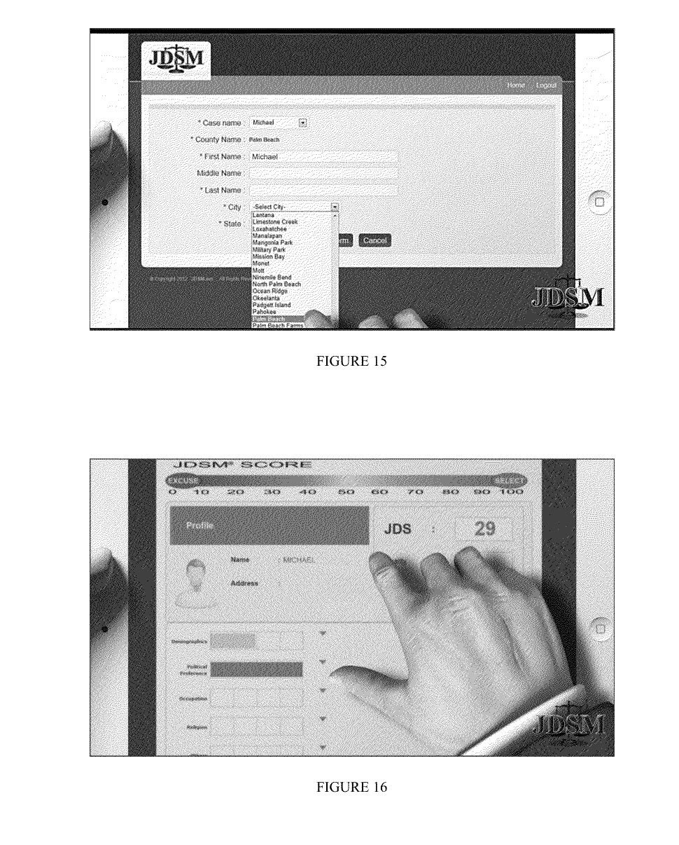

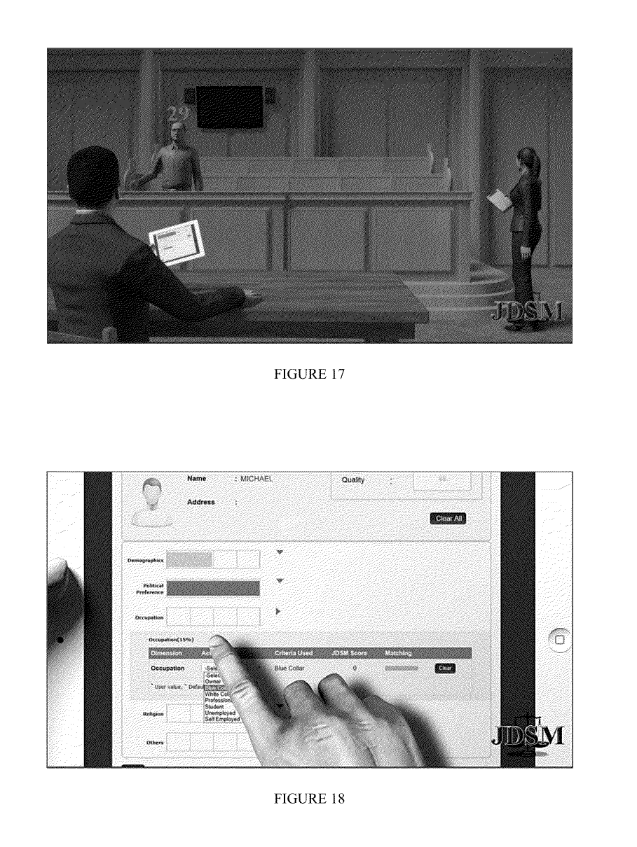

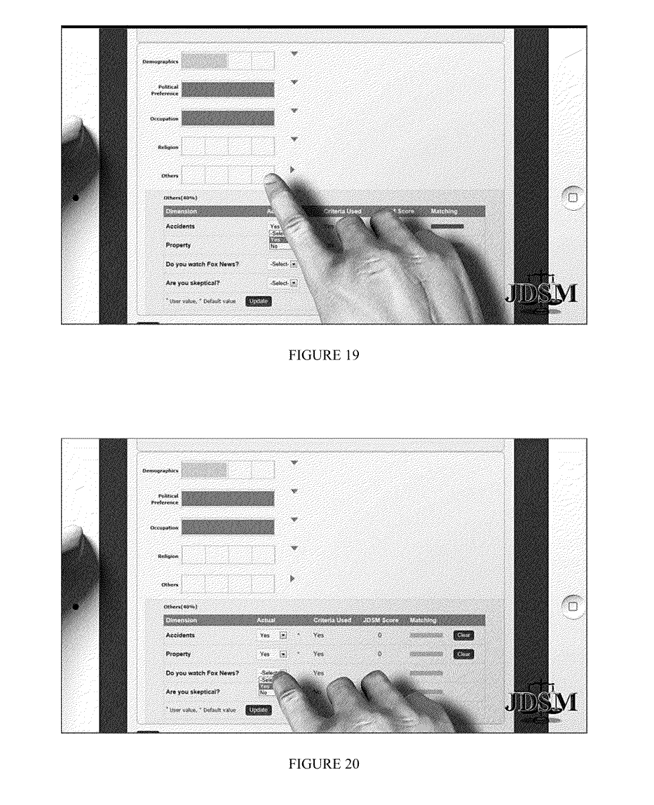

Once the juror information is entered, a data search is completed mining millions of public and social data records which are analyzed in real time and raw information is converted into predictive, objective and usable juror specific data with algorithm analysis and then correlated to pre-selected critical case parameters, which are further filtered with updated or modified information obtained during Voir Dire to generate an enhanced Jury Deliberation Selection Measure numerical and color score for each potential juror who is then selected or deselected (FIGS. 13, 17, 18, 19, 20 & 25). In addition, searched information will be maintained in a secure data cloud for future access (FIGS. 1, 2 & 4). For example, if a potential juror served on a jury in one venue, that information would be securely saved and available at other locations for possible future comparison or utilization.

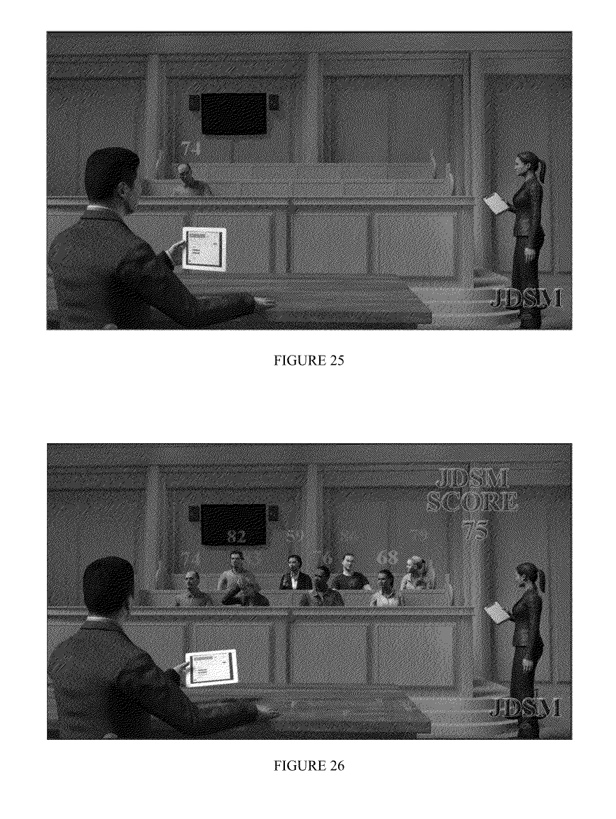

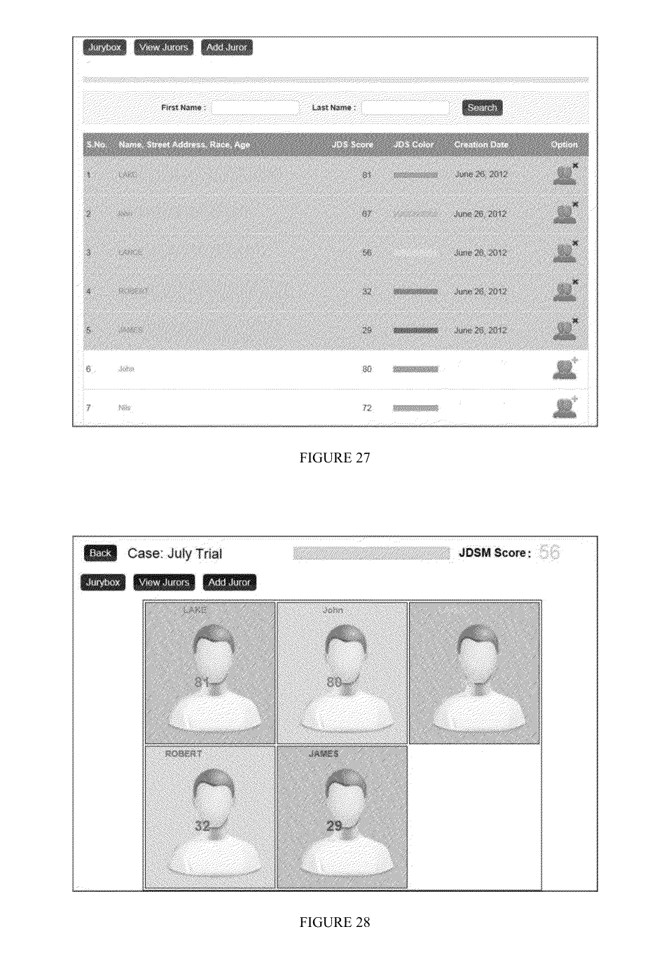

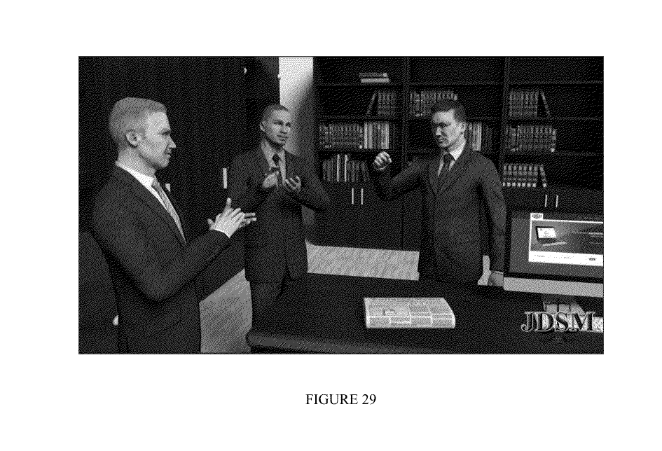

Finally, the ability to access via a secure graphical user interface, the aggregate jury box Jury Deliberation Selection Measure numerical and color score as well as switching between selected jurors of the jury box and overall jury pool in real time with both the numerical and color score to assist the attorney in making quicker decisions regarding selection or deselection (FIGS. 26, 27, 28).

It should be noted that the present invention will be offered as an application via download or online utilizing a browser with secure online payment per searched juror. Application software is designed to help the attorneys perform selected tasks and downloaded from various sites such as Google Android, Apple iOS (or developing sites). Browsers include Chrome, Internet Explorer, Firefox, Safari, Android, Opera (or other developing) browsers based on mobile or non-mobile devices utilized for retrieving, presenting and traversing information over an internal intranet or external internet. The cloud is used as a metaphor for internet based systems of mobile or non-mobile devices, connected wired and wirelessly to securely and seamlessly integrate all attorney, juror and case information so it can be accessed from anywhere at any time, providing real time data about the jury selection and deselection process.

Thus, having described the various embodiments, it should be recognized by those of skill in the art of this process, application and programming design, that alternative formats may be developed and utilized without departing from the scope and spirit of this invention. Accordingly, the above description should not be taken as limiting this invention, which is further defined in the claims.

We claim:

1. The method utilizes the internet cloud or device specific application secure graphical user interface gateway for attorneys to login via user name and password, from anywhere, on any mobile or non-mobile device such as, smart phones, iPhones, iPads, tablets, tablet PCs, laptops, netbooks, ultrabooks, personal computers, surfaces, data enabled phones via wired or wireless.

2. The method utilizes initial setup via the internet cloud or device specific application from anywhere, on any mobile or non-mobile device using a secure graphical user interface to input case name, state, county, plaintiff, critical case parameter categories and with confirming weighting that sum to 100%.

3. The method utilizes critical case parameters of race, education, age and gender, political preference, occupation, religious preference and with other category; other category includes prior accidents, property ownership, bankruptcy, corporate filings, preferences of news shows, personality types, a determination of skepticism, rules observed, optimistic or not plus open fields to input attorneys' own case specific variables with confirming weighting that sum to 100%.

4. The method utilizes the internet cloud or device specific application from anywhere, on any mobile or non-mobile device using a secure graphical user interface to input potential jurors information during Voir Dire with name and address, then searching millions of public and social records in real time to obtain a jurors' background, which is analyzed in real time and raw information is converted into predictive, objective and usable juror specific data with a Jury Deliberation Selection Measure numerical and color score generated, which is then stored on secure mobile device, non-mobile device or the internet cloud.

5. The method as recited in claims 2, 3 and 4 will provide the ability to incrementally update or modify case parameters or juror information at anytime from anywhere, before, during or after Voir Dire, utilizing the attorney team to obtain real time updated Jury Deliberation Selection Measure numerical and color scoring.

6. The method uses numerical scoring for quicker visual selection or deselection of jurors as recited in claims 4 and 5, with scores ranging from 0-100 to provide feedback with lower numbers 0-49 indicating deselection and increasing numbers 50-100 indicating selection.

7. The method uses color scoring for quicker visual selection or deselection of jurors as recited in claims 4 and 5, with colors ranging from red, orange, yellow, light green and finally dark green to provide feedback with red end of the spectrum indicating deselection and dark green end of the spectrum indicating selection.

8. The method also provides a quality score of 0-100 indicating correlation of data to preset critical case parameters for any Jury Deliberation Selection Measure numerical and color score as recited in claims 6 and 7.

9. The method also provides the ability to select or deselect a total jury panel and to place them as an aggregate into a jury box showing each individuals Jury Deliberation Selection Measure numerical and color score, an image of each individual juror in the jury box as well as a total composite numerical and color score for all jurors selected to the jury box.

10. The method provides the ability to utilize any wired or wireless network such as Internet Service Provider, Wide Area Network, Code Division Multiple Access, Evolution Data Optimized, Enhanced Data Rates for GSM Evolution, 3GSM, Digital AMPS, Integrated Digital Enhanced Network, WiMAX, Wireless Local Area Network, Wired Equivalent Privacy, WiFi Protected Access, Peer to Peer, 3rd Generation, 3GPP Long Term Evolution, 4th Generation or Virtual Private Network.
